(19) United States
(12) Patent Application Publication
(10) Pub. No.: US 2025/0320746 A1
(43) Pub. Date: Oct. 16, 2025

(54) PASSIVE SLED MODULES, CAMP SYSTEMS, AND RELATED METHODS OF USE

(71) Applicant: Roger Moore, Calgary (CA)

(72) Inventor: Roger Moore, Calgary (CA)

(21) Appl. No.: 19/035,568

(22) Filed: Jan. 23, 2025

(30) Foreign Application Priority Data
Jan. 26, 2024 (CA) 3,227,441

(51) Int. Cl. E04H 15/06; B62B 15/00; B62M 27/02; E04H 15/12

(52) U.S. Cl. CPC E04H 15/06; B62B 15/007; E04H 15/12; B62B 2202/30; B62M 27/02

(57) ABSTRACT

A camp system has: a plurality of sleds spaced from one another about a ground surface; and a tarpaulin secured in a deployed position between the plurality of sleds and defining an enclosed interior camping area. A method of use includes: arranging a plurality of sleds at a camp site; and deploying a tarpaulin to or over the plurality of sleds to form an enclosed interior camping area between the plurality of sleds. A passive sled has: a hollow tub base; a camper housing with side walls and a roof mounted over the hollow tub base and defining an enclosed interior sleeping area with a bed within the interior sleeping area; and a tow mount at a front end of the passive sled.

### TECHNICAL FIELD

This document relates to passive sled modules, camp systems, and related methods of use.

### BACKGROUND

The following information is not an admission that anything discussed in them is prior art or part of the knowledge of persons skilled in the art.

Recreational vehicles are known to be expandable by corridors that connect with an adjacent tent. Ice fishing and other similar sleds are known to have bases that either deploy a tent overhead or can be enveloped by a tent.

### SUMMARY

A camp system is disclosed comprising: a plurality of sleds spaced from one another about a ground surface; and a tarpaulin secured in a deployed position between the plurality of sleds and defining an enclosed interior camping area.

A method is disclosed comprising: arranging a plurality of sleds at a camp site; and deploying a tarpaulin to or over the plurality of sleds to form an enclosed interior camping area between the plurality of sleds.

A passive sled module is disclosed comprising: a hollow tub base; a camper housing with side walls and a roof mounted over the hollow tub base and defining an enclosed interior sleeping area with a bed within the interior sleeping area; and a tow mount at a front end of the passive sled.

In various embodiments, there may be included any one or more of the following features: One or more sleds of the plurality of sleds comprise a hollow tub base. The hollow tub base comprises plastic. The one or more sleds of the plurality of sleds each form a camper housing, with side walls and a roof mounted over the hollow tub base and defining an enclosed interior sleeping area. The camper housing comprises a bed within the interior sleeping area. The bed is sized for one or more average adults. The one or more sleds of the plurality of sleds are passive sleds. The passive sleds each comprise a tow mount at a front end of the passive sled. The one or more sleds each comprise runners. The one or more sleds each comprise a furnace. The camp system is deployed over a snowy or icy ground surface. The tarpaulin is mounted, at least in part, to one or more of the plurality of sleds. The tarpaulin is mounted to move between the deployed position and a stowed position where the tarpaulin is stowed on or within the one or more of the plurality of sleds. The tarpaulin is formed of a plurality of tarpaulin modules, with each of the plurality of sleds mounting a respective tarpaulin module of the plurality of tarpaulin modules, and with each of the plurality of tarpaulin modules being reversibly securable to the other tarpaulin modules to form the tarpaulin when in the deployed position. Each of the plurality of tarpaulin modules is reversibly securable to one or more other tarpaulin modules by a zipper, strap, tie down, or hook and loop fastening system. A sled for use in the camp system. Transporting the plurality of sleds and tarpaulin to the camp site. Transporting comprises pulling the plurality of sleds using all-terrain vehicles. The all-terrain vehicles comprise snowmobiles.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is side elevation view of a passive sled module with a camper housing.

FIG. 2 is bottom plan view of the passive sled module of FIG. 1.

FIG. 3 is a side elevation view of a roof rack for the passive sled module of FIG. 1.

FIG. 4 is a top plan view of the roof rack of FIG. 3.

FIGS. 5 and 6 are rear and front elevation views, respectively, of the passive sled module of FIG. 1.

FIG. 7 is a camp system assembled with two of the passive sled modules of FIG. 1.

FIG. 8 is a front-end view of the camp system of FIG. 7, with the front wall removed to illustrate the interior of the camp system.

FIG. 9 is a top plan view of the camp system of FIG. 7 with interior components shown in dashed lines for illustration.

FIG. 10 is a top plan view of a camp system assembled with three of the passive sled modules of FIG. 1.

FIG. 11 is a top plan view of a camp system assembled with four of the passive sled modules of FIG. 1.

FIG. 12 is a perspective view of an embodiment of a passive sled module with a stove compartment and a furnace compartment, both in an open position.

FIG. 13 is a perspective view of the passive sled module of FIG. 12 with the stove and furnace compartments in a closed position and the camper housing in an open position.

FIG. 14 is a side elevation view of the passive sled module of FIG. 12, with both the stove and furnace compartments in the open position, and the camper housing in the open position.

FIG. 15 is a side elevation view of the exhaust side of the furnace compartment of the passive sled module of FIG. 12, in a closed position.

FIG. 16 is a side elevation view of the exhaust side of the furnace compartment of FIG. 15 in an open position.

### DETAILED DESCRIPTION

Immaterial modifications may be made to the embodiments described here without departing from what is covered by the claims.

Camping is a popular outdoor recreational activity that involves setting up temporary shelters and living in natural environments, typically away from urban areas. Campers use a variety of equipment and techniques to make their stay comfortable and safe. Common camping equipment includes tents, sleeping bags, cooking stoves, and portable lighting. Depending on the level of sophistication and the specific type of camping, campers may also use specialized gear such as backpacks, GPS devices, and water purification systems. Camping allows individuals to connect with nature, engage in activities such as hiking and fishing, and enjoy the serenity of the outdoors.

Camping in winter, often referred to as winter camping or cold-weather camping, presents distinct challenges and requires specialized equipment to ensure safety and comfort in harsh weather conditions. In addition to the standard camping gear, winter campers must incorporate insulated clothing, cold weather sleeping bags, and four-season tents designed to withstand heavy snow loads and provide better insulation. Snowshoes or skis may be used for transportation through snow-covered terrain, and campers may need to be well-versed in cold-weather survival skills, such as building snow shelters or igloos. Heating sources, like portable stoves or campfires, become critical for staying warm, and managing condensation inside the shelter is essential to prevent moisture-related issues like frostbite. Careful planning, knowledge of winter hazards, and proper gear are key elements to enjoy the unique experience of winter camping safely.

In the context of camping, All-Terrain Vehicles (ATVs) serve as versatile tools for transporting gear, exploring remote camping sites, and accessing rugged outdoor locations. Their robust construction, powerful engines, and off-road capabilities make them indispensable for campers looking to carry equipment into wilderness areas and set up camp in more remote and challenging terrains. ATVs are especially useful for hauling heavy loads, such as tents, cooking supplies, and firewood, over rough trails or through dense forests.

During winter camping expeditions, ATVs can be indispensable assets for navigating snow-covered landscapes and transporting camping gear in colder climates. Winterized ATVs, often equipped with snow tracks or skis, provide enhanced mobility on icy and snowy terrain, ensuring campers can access remote winter camping destinations effectively. These specialized ATVs may come with features like electric hand warmers and heated handlebars to keep riders comfortable during frigid temperatures. However, winter ATV operation requires extra caution, as snow and ice can pose unique challenges, such as reduced traction and increased risks of getting stuck. Proper winter driving skills, knowledge of the terrain, and the use of essential safety equipment are crucial for a successful and safe winter camping experience with ATVs.

Snowmobiles are a category of ATVs optimized for snow and winter environments and are another excellent option for winter camping. These vehicles feature a design specifically tailored for traversing snow-covered terrains, making them ideal for accessing remote camping sites during the winter season. Snowmobiles offer an even higher level of snow mobility than traditional ATVs, thanks to powerful engines, snow tracks, and skis, which provide superior traction and stability on icy and snowy surfaces. A snowmobile's capacity for carrying camping equipment and supplies, along with the added benefit of a windscreen or heated handlebars for cold-weather comfort, makes the snowmobile a popular choice for winter camping enthusiasts.

Snowmobile tow sleds, often referred to as snowmobile cargo sleds or sled trailers, are specialized equipment designed to be towed behind a snowmobile to transport gear and supplies in winter environments. These sleds are typically constructed with durable materials like high-density polyethylene (HDPE) or reinforced fiberglass to withstand the rigors of off-road travel. They feature a low-friction design, which allows them to glide smoothly over snow and ice, reducing the strain on the snowmobile and the rider. Their structural features may include reinforced frames made of lightweight yet robust materials like aluminum or steel, ensuring the sled's ability to withstand the rigors of rough terrain. Many passive sleds are designed with ergonomic and practical considerations, such as molded runners for added stability, tie-down points for securing cargo, and molded-in handles or attachment points for securing ropes or harnesses. Additionally, some models may incorporate features like hinged or detachable lids for weather protection or additional storage compartments. The design of these passive sleds aims to provide a dependable and convenient means of transporting gear and supplies in harsh winter conditions, contributing to a more enjoyable and efficient camping, hunting, and fishing experience. Snowmobile tow sleds come in various sizes and configurations, accommodating a range of cargo loads, from camping equipment and firewood to hunting gear and provisions. These sleds are essential tools for winter enthusiasts, making it easier to transport heavy loads while exploring snowy wilderness areas and enhancing the overall winter outdoor experience.

Hunting and fishing are outdoor activities that often involve camping and related techniques, and that in the context of winter, involve the use of ATVs such as snowmobiles. In hunting, participants employ various firearms, bows, or other tools to pursue and capture wild animals, often adhering to strict regulations that govern seasons, quotas, and permitted species. Many hunters frequently use camping equipment to access remote areas, making camping an integral part of the experience. Conversely, fishing is the practice of catching fish, using techniques such as angling, netting, and spearing. Modern technologies, including GPS, sonar, and advanced optics, have advanced these activities, aiding participants in their pursuit of game and fish while accessing remote and challenging terrains. Snowmobiles and camp systems can be used to allow winter hunters and fishermen to access almost any remote area, over extended periods of time, in order to carry out the above-mentioned activities.

Planning a campsite in a remote winter area may traditionally involve a systematic and thorough approach to ensure the safety and comfort of the campers. Firstly, a comprehensive trip plan is established, taking into account the intended location, duration of stay, and anticipated weather conditions. Campers carefully select a shelter site, considering factors like proximity to water sources, wind protection, and accessibility to the chosen terrain. Winter campers typically bring four-season tents or may opt for snow shelters like snow caves or quinzhees, constructed by compacting and excavating snow. Clearing the chosen site of snow is necessary, as it helps create a level platform for setting up the shelter and prevents moisture from melting snow. Adequate insulation through high-quality sleeping bags, sleeping pads, and warm clothing is essential to combat sub-freezing temperatures. Additionally, snowshoes or skis are employed for ease of movement, especially in deep snow. Campers often transport heavy equipment, supplies, and provisions using sleds or cargo sleds, which can be pulled by individuals or towed by snowmobiles where applicable. Ensuring the availability of portable stoves for cooking and heating is important. A secure food storage system is also set up to prevent wildlife encounters in remote wilderness areas. Effective planning and preparation are paramount for a successful winter camping experience in a remote location, demanding a high level of skill, knowledge, and attention to detail.

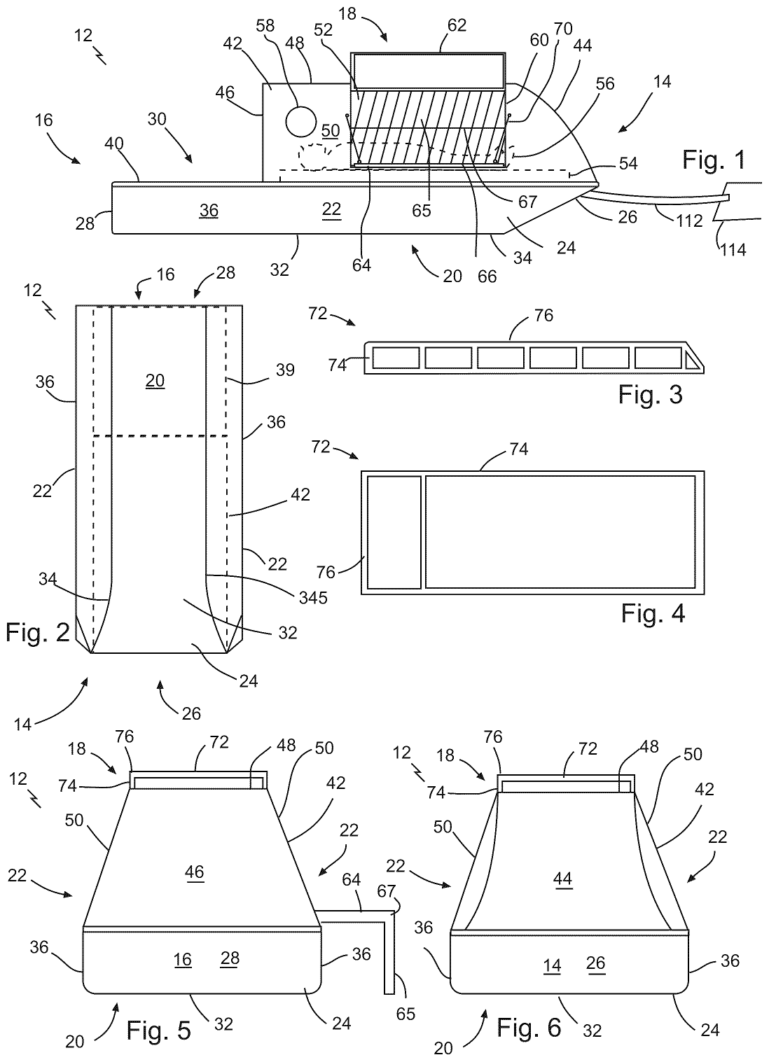

Referring to FIGS. 1-9, a sled 12 is shown that may be used to form a temporary camp system 10. Camp system 10 may be assembled by arranging a plurality of sleds 12 at a camping site, for example spaced from one another about a ground surface 110. A tarpaulin 78 may be deployed, for example secured in a deployed position to or over the plurality of sleds 12, for example between the plurality of sleds 12 to define an enclosed interior camping area. Sled 12 may thus form a sled module, which can be used with one, two, three, or more other sled modules to form the camp system 10. Camp system 10 may be deployed over a snowy or icy ground surface 110.

Referring to FIGS. 1-6, sled 12 may have suitable features. The sled 12 may have a hollow tub base 24. The tub base 24 may be made of suitable materials, for example plastic. In some cases, the tub base 24 may be a plastic molded part, for example an injection molded part. The sled 12 may have a camper housing 42, for example with side walls 36 and a roof 48. The camper housing 42 may be mounted over the hollow tub base 24. The camper housing 42 may define an enclosed interior sleeping area 52. A bed 54 may be located within the interior sleeping area 52. Bed 54 may be sized for one or more average adults. The bed may include a rigid support surface, upon which a mattress rests. A user 56 may in use, lie on the bed 54 as shown to get rest or sleep.

Referring to FIGS. 1-6, sled 12 may be a passive sled. A passive sled may be a type of sled or toboggan designed for use in cold weather conditions, typically over snow or ice. Unlike active sleds that are meant for recreational purposes and can be steered, passive sleds may not have any means of control or steering by the person riding on them. Instead, they are primarily used for transporting cargo or equipment across snowy or icy terrain. Passive sleds may be pulled or towed by a person, animal, or motorized vehicle, and their design often includes low-friction materials on the bottom surface to reduce drag and make them easier to pull. They are commonly used for activities such as winter camping, hunting, ice fishing, or any situation where the efficient movement of supplies or gear over snowy or icy surfaces is required. Passive sleds may also not incorporate any type of drive, such as a motor, relying instead on a vehicle or other external driver to move the sled. The sled 12 may comprise a tow connector 112 at or near a front end 14 of the passive sled 12. In the example shown, the tow connector 112 comprises a pair of straps that can be manually hooked or otherwise connected, for example by a latch or clasp system, to a tow vehicle, such as a snowmobile 114 (FIG. 1). Other tow connector may be used, such as a hitch assembly, a tow bar, a pintle hitch, and other hitches.

Referring to FIGS. 1-6, sled 12 may be configured for sliding over a snowy ground surface, and thus may comprise runners, such as side runner ridges 34. Runners on a passive sled that may influence the sled's performance and functionality. Runners are typically long, narrow strips or rails located on the sled's bottom surface, and they play a critical role in reducing friction with the snow or ice. Runners are often made of materials like high-density polyethylene (HDPE) or other low-friction plastics, which allow the sled to slide smoothly and efficiently across wintry surfaces. The design and quality of these runners are crucial, as they determine the sled's stability, ease of towing, and resistance to wear and tear. Well-constructed runners enhance the sled's ability to navigate uneven terrains, maintain a straight trajectory, and minimize the effort required to pull the sled, making them an integral part of passive sleds designed for transporting cargo and equipment in snowy environments. Alternatives to runners in a passive sled are less common but can be used depending on specific requirements and the type of terrain the sled will be used on. Some of these alternatives include skis-using small skis instead of runners can provide a smooth gliding surface. Skis are particularly useful on very icy surfaces or in areas with uneven terrain. Another alternative is a low-friction coating: Some passive sleds may incorporate a low-friction coating on the sled's bottom surface, such as PTFE (Teflon) or UHMW (Ultra-High-Molecular-Weight) polyethylene, to reduce friction and allow the sled to slide more easily. Another alternative is a slick fabric-covering the sled's bottom with a slick, durable fabric material, like nylon or Cordura™ can reduce friction and provide a relatively smooth sliding surface. Wooden Slats may be used-in traditional sled designs, wooden slats or boards may be used in place of runners. While not as low-friction as plastic materials, wooden slats can work effectively in certain snow conditions. Hybrid designs may be used-some sleds may incorporate a combination of the above options, using both runners and other low-friction materials to balance performance and durability. The choice of alternative to runners depends on factors such as the sled's intended use, the type of snow or ice it will encounter, and the specific demands of the terrain. Selecting the right material or design is crucial to ensure optimal performance and ease of use.

Referring to FIGS. 1-6, sled 12 may have other suitable features. The sled 12 may define a front end 14, a rear end, a top 18 a base 20, and side walls 22. A hollow tub base 24 may have a suitable front end 14, such as a sloped front end 26, which tapers with increasing distance from a ground-contact plane defined by lowest point of the base 20. A tapered front end may assist in minimizing friction with snow and ice, and in facilitating the traversing of bumps, rises, and falls in terrain. The tub base 24 may have a rear wall 28 defining the rear end 16 and may define a hollow interior 38 bounded by a top peripheral edge 40 of the base 24. The tub base 24 may be formed with an open top 30, which may have mounted to it a cover 39 to enclose the hollow interior 38 during transport or otherwise to enclose a storage space within interior 38. In use, user 56 may use the hollow interior 38 to store various components required for the specific outdoor activity being carried out, such as guns or camping supplies. The tub base 24 of a sled 12 may provide a sturdy, curved or bowl-shaped enclosure made from materials like high-density polyethylene (HDPE) or durable plastics. This tub-shaped design serves to contain cargo, equipment, or passengers, providing a secure and spacious compartment for transporting various items. The tub base may be a useful aspect of a passive sled used in activities such as winter camping, hunting, and ice fishing, as it allows for the safe and efficient transport of gear and supplies across snowy or icy terrain. Its ergonomic shape not only provides ample storage capacity but also aids in distributing the load evenly, enhancing stability and maneuverability. Additionally, the tub base may feature reinforced walls or attachment points for securing cargo and often includes a durable, low-friction bottom surface, such as runners or a slick coating, to reduce friction and facilitate smooth movement over snow and ice.

Referring to FIGS. 1-6, the camper housing 42 (camper unit) may have suitable features. The camper unit may be configured as a solo camping unit. The camper housing 42 may provide a compact and lightweight shelter designed to accommodate one individual during outdoor adventures. The housing 42 may have a front wall 44, a rear wall 46, a roof 48, and side walls 50, which may define a hollow interior sleeping area 52, housing 42 may comprise a door hatch opening 60, which may include a door 62, which may be connected by a hinge 66 or by other mechanisms to open and close. The door 62 in the example shown may be structured to move between a closed position (shown in FIG. 1), and a seat deployed position (shown in FIG. 5). In the seat deployed position, door 62 may swing outward and in some cases, pivot downward about a pivot or hinge 67 to define a ground engaging leg 65 or legs and a seating surface 64. One or more lever arms, such as gas struts 70 may be provided to support and assist in movement of the door 62 between positions.

Referring to FIGS. 1-6, the camper housing 42 (camper unit) may have suitable other features. The camper housing 42 may be designed to minimize weight and maximize space efficiency. Despite its compact size, the camper housing 42 may offer a comfortable and enclosed sleeping area with sufficient headroom and storage pockets, shelves, or cabinets for gear organization. Solo camping units with panel walls represent a modern and innovative approach to outdoor accommodations for individual adventurers. These units may be characterized by their use of rigid panel walls, typically made from lightweight yet durable materials like fiberglass-reinforced composites or aluminum. The panel walls may provide a rigid and sturdy structure, offering excellent insulation, weather resistance, and soundproofing capabilities. One or more windows 58 may be provided. One or more vents or fans (not shown) may be provided for circulation of air. A heating unit (not shown) may be provided for heating the interior of the camper unit. The camper housing 42 may provide the sled 12 with flexibility to be used by a solo camper in the absence of forming part of a greater camp system 10 to enjoy enhanced comfort and protection from the elements while maintaining a manageable weight for transport, or to be used as a group of sleds 12 to produce a camp system 10 of plural sleds 12 and a tarpaulin 78. Modular construction may allow for quick assembly and disassembly, making them convenient for solo travelers and teams of campers. Housing 42 may mount a roof rack 72 for additional storage above the housing 42. The roof rack 72 may be made of suitable structural members, such as frame walls 74 defining a top peripheral edge 76. The panel walls 44, 46, and 50, and roof 48 (and any base structure such as bed 54 or a floor (not shown)) may include insulation to regulate temperature, making these units suitable for a range of climates. Camper housing 42 may feature integrated solar panels for power generation or foldable furniture to optimize space utilization. A solar-powered camper housing 42 may combine technical excellence with a compact and minimalist design, making it a preferred choice for solo and team adventurers who value comfort, mobility, and protection during their outdoor escapades. Although an embodiment with rigid side walls is shown, in some cases a solo camper housing 42 may be constructed using lightweight materials like nylon or polyester and come with aluminum or fiberglass tent poles to maintain structural integrity while keeping weight to a minimum.

Referring to FIGS. 1-6, bed 54 may have a suitable structure. Bed 54 may comprise a mattress as shown. A suitable camping mattress may be made of lightweight, compact materials such as foam or inflatable materials, designed to be portable and easy to transport. Such materials may provide insulation from the cold ground and cushioning for a more comfortable rest. Bed 54 may alternatively be an inflatable bed 54. In recent years, innovative alternatives to traditional mattresses have emerged, including self-inflating mats, air pads, and even hammocks with built-in supports. These alternatives offer varying degrees of comfort, insulation, and packability, catering to different camping preferences and conditions. Self-inflating mats, for instance, strike a balance between comfort and portability, while air pads provide superior cushioning. Hammocks, on the other hand, offer a unique camping experience, suspending campers off the ground. The choice of mattress or alternative depends on the camper's specific needs, the type of camping, and the level of comfort desired, but they all contribute to a more enjoyable and well-rested outdoor experience.

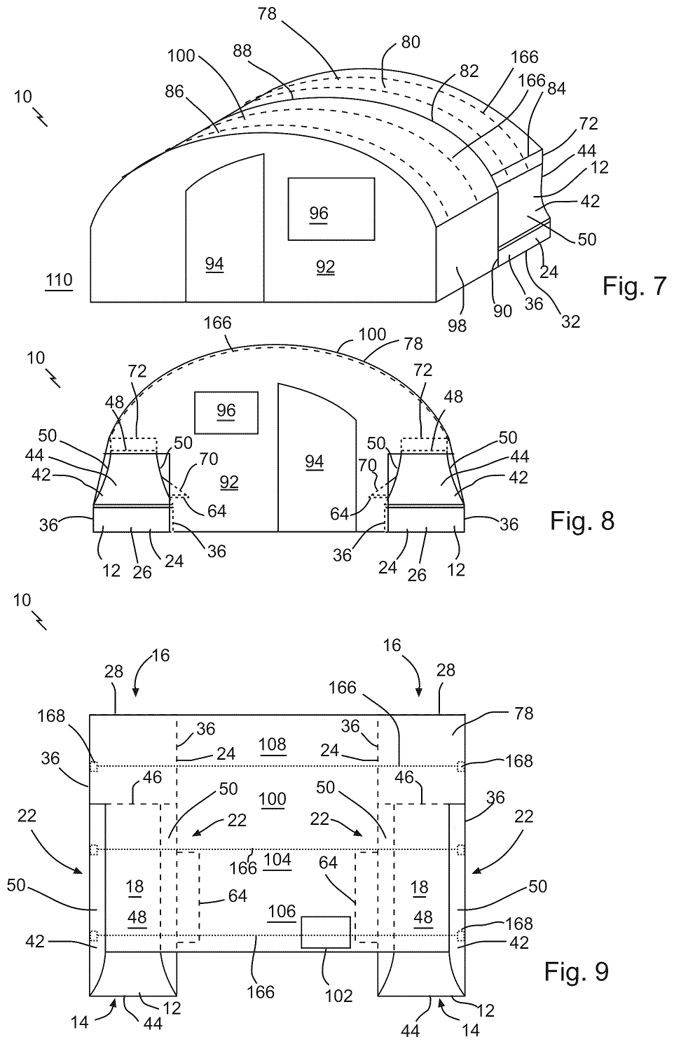

Referring to FIGS. 7-9, plural sleds 12 may be combined with a tarpaulin 78 to form a camp system 10. In the deployed position shown, the tarpaulin 78 may be mounted, at least in part, to one or more of the plurality of sleds 12. The tarpaulin 78 may be mounted to move between the deployed position and a stowed position where the tarpaulin is stowed on or within the one or more of the plurality of sleds. For example, the tarpaulin 78 or part of it may be mounted to retract into a housing on one of the sleds 12, for storage. In other cases, the tarpaulin 78 may be assembled by connecting the tarpaulin 78 to the various sleds 12, for example by suitable reversible connectors such as zipper, strap, tie down, hook and loop fastening systems, or other mechanisms. The tarpaulin 78 may be configured to incorporate one or more structural tent elements such as collapsible tent poles 166, which may be collapsible fiberglass rods that are hollow to receive a bungee cord therein and that can assemble into an arched or other suitable structure to support the tarpaulin to the desired height, such as in the arched fashion with about seven feet or more of vertical clearance at the apex. Tent poles provide structural support. They may be collapsible for easier transport and storage. Some designs use rigid poles, typically made of metal, or sometimes wood. Other designs use semi-rigid poles, typically made of fiberglass, or sometimes of special metal alloys. Another pole type uses inflatable beams as the structural support. Some tents, particularly very lightweight models, actually use hiking poles as their structural supports. The ends of the tent poles 166 may be received by suitable mounts, such as fabric pockets 168, or other types of mounts.

Referring to FIGS. 7-9, the tarpaulin 78 may be formed of a plurality of tarpaulin modules. For example, the tarpaulin 78 may be made up of a first segment 80 and a second segment 86, although more than two segments may be provided. Each of the plurality of sleds 12 may mount a respective tarpaulin module of the plurality of tarpaulin modules. In some cases, the plurality of tarpaulin modules are arrayed over the plural sleds 12 and added to or removed to provide a sufficient cover to enclose the camp system 10 independently or collectively with the sleds 12. Each of the plurality of tarpaulin modules may be reversibly securable to the other tarpaulin modules to form the tarpaulin when in the deployed position. Each of the plurality of tarpaulin modules may be reversibly securable to one or more other tarpaulin modules by a zipper or hook and loop fastening system. In the example shown, the first segment 80 may define a first mating end edge 82 that mates in the deployed position with a mating end edge 88 of the second segment 86. Mating base edges 84 and 90 of the first and second segments 80 and 86, respectively, may connect to the sleds 12. End walls 92 may be provided, either as tarpaulin modules, or as part of the first or second segments 80, 86, respectively.

Referring to FIGS. 7-9, various other components may be provided or defined in the tarpaulin 78 to provide an enclosed, functional camping shelter. For example, one or more doors 94 may be provided, for example within a door hatch opening for ease of access to and from an interior 104 of the camp system 10. Doors 94 may be connected to open by suitable methods, such as by use of flexible material that might be secured by zipper or strap, or by hinge. One or more windows 96 may be provided. Side walls 98 may be provided, either as separate tarpaulin modules, or as part of the sleds 12 themselves. Parts of the sleds 12 may extend beyond the perimeter of the interior 104 defined by the tarpaulin 78, for example front ends 14 of the sleds 12 in the example of FIGS. 8 and 9. The tarpaulin 78 may define a roof 100 that extends above and defines the interior 104. One or more vents 102 may be defined in the roof 100. The interior 104 of the enclosed camp system 10 may include one or more sled zones 106, in which a respective sled 12 is located, and oriented to connect the door 62 to the interior 104 so that a user 56 may enter and exit a respective camper housing 42 from within the interior 104 without going to the exterior of the camp system 10. Living space zone 108 may be defined between the sleds 12, which are separated to define the living space zone 108. A heating unit (not shown) may be provided in interior 104, such as a wood stove, furnace, or electric heater. Proper ventilation may be provided depending on the needs of the camp system 10.

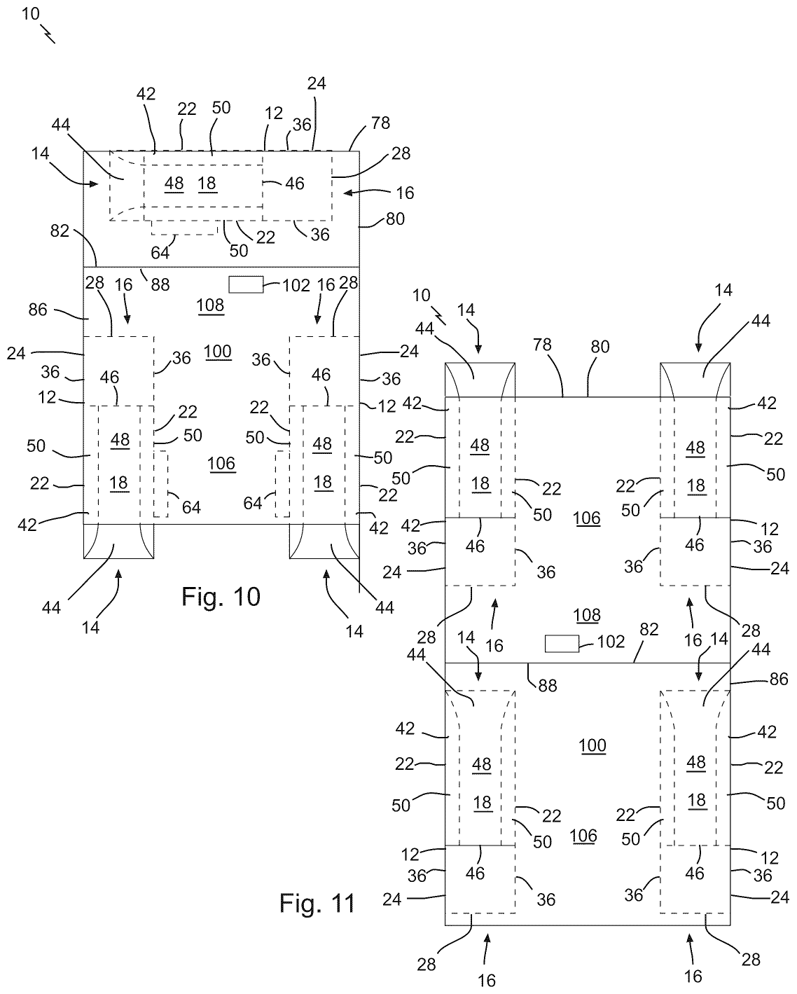

Referring to FIGS. 7-9, camp system 10 may be set up in a suitable manner. The plurality of sleds 12 and tarpaulin 78 may be transported to the camp site, for example by pulling the plurality of sleds 12 using all-terrain vehicles such as snowmobiles 114. Once in place, sleds 12 may be arranged in a suitable orientation and spacing from one another. The tarpaulin 78 or respective tarpaulin modules, may be assembled and secured between sleds 12 and/or the ground surface 110, to enclose an interior 104 to provide an internal living space zone 108 that is protected from exterior elements. The tarpaulin 78 may need to be secured to the ground surface 110 by stakes and ropes (not shown) for extra support. Referring to FIGS. 10 and 11, various other configurations of camp systems 10 may be assembled, for example ones that use three or four sleds 12 (shown in FIGS. 10 and 11, respectively). Other configurations may be used.

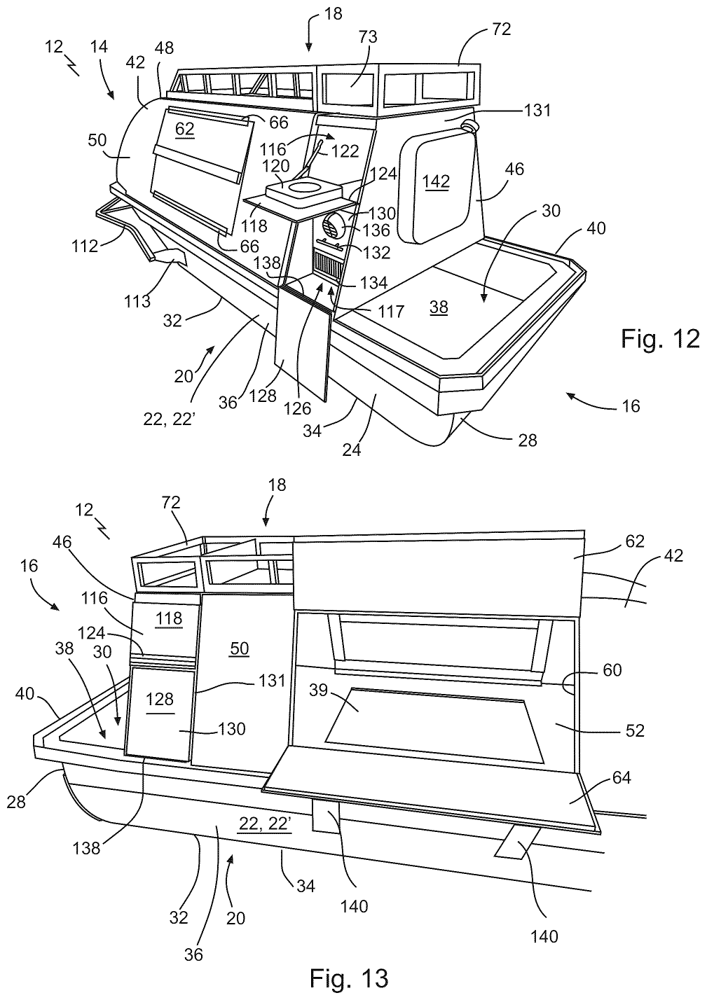

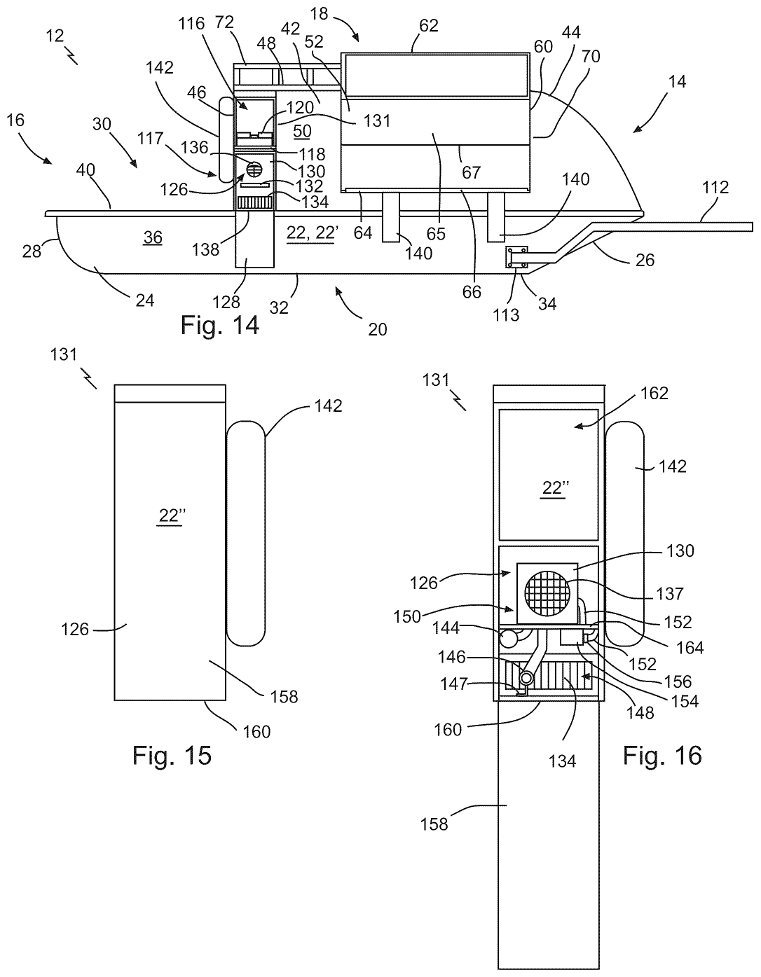

Referring to FIGS. 12-16, another embodiment of a sled 12 is illustrated. The sled 12 incorporates a heating system, in this case a furnace 130. A structural frame 131 for the furnace 130 may be provided on the sled 12, for example at a rear end of the camper unit 42 (or at another suitable location on the sled 12). The frame 131 may define one or more compartments, such as one or more of a stove compartment 116, a furnace compartment 126, and a storage compartment 162. The compartments may include one or more access doors, such as a stove compartment door 118, a front furnace compartment door 128, and a rear furnace door 158. The aforementioned doors may include suitable mechanisms for opening and in some cases securing (such as locking) such as hinges 124, 138, and 160. The furnace compartment 126 may include suitable parts, such as a furnace 130, a fresh air intake 137, an air return grating 134, a hot air supply 136, a furnace exhaust 146, and a furnace intake 144. In the example shown, the furnace 130 is oriented to heat air on an inner side 22′ of the sled 12, while ingesting fresh air from, and exhausting combustion air out, of an outside side 22″ of the sled 12. Thus, the sled 12 may be used to define part of the walls of a larger tent system in use. In other cases, the furnace 130 may vent and/or ingest fresh air from other areas, such as above the sled 12. The hot air supply 136 may be configured as a hose connector, similar to a boat heater that might have an optional flexible tube (not shown) to connect and disconnect from to direct hot air as desired by the user. The furnace system may incorporate an air return, such as via an air return passage 148 from grating 134. The furnace 130 may be located on a partition shelf 164 above the air return passage 148, although other orientations may be used. The exhaust 146 may be mounted to the compartment 126 via a suitable part such as a bracket 147. Fuel for the furnace 130 may be provided by a suitable mechanism, such as a hose 152 from a fuel tank, such as a diesel fuel tank 142, although other types of fuel may be used such as natural gas or propane. A fuel hose 152 may run from tank 142 through a filter 152 and pump 156 into furnace 130. The furnace 130 may operate by cycling fresh air from outside to the inside of the camp through a heat exchanger 150 that transfers heat from combustion air also cycling through the furnace 130 but without mixing with such combustion air. The furnace 130 or part of it may be provided in modular fashion, such as part of a removable furnace section 117 that includes the furnace 130, and all the components in the compartment 126. The section 117 may be installed and removed using a handle 132. In the example shown, the modular furnace insert section 117 may be removed by unbolting it from the frame, and removing it laterally from the compartment. In other cases, the section 117 may be configured to be slid in and out of the compartment for replacement, for example if the section 117 were mounted on rails. A locking part or parts, such as a latch mechanism, may be used to secure the furnace section 117 in place for reversible uninstallation. A controller or set of controls may be provided (not shown). In some cases, the furnace 130 may be operable by remote, for example via a Bluetooth control system, for further example via a software application on a mobile phone. A stove burner 120 may be provided, for example in stove compartment 116, the burner 120 may be provided as part of door 118, and may be supported by one or more struts or braces 122. The stove burner 120 may be connected to operate with the same fuel source as the furnace 130. The stove may be provided with an electric element in some cases, which may be powered by a source of electricity. One or more batteries (not shown) or other electricity sources such as solar panels, may be provided to provide electricity to operate the stove and/or furnace. The sled 12 may incorporate other features such as one or more braces 140 to support the ledge or seating surface 64. A suitable tow connector 112 may be used, for example including a bolted tow connector mount 113. A divider 73 on the roof rack 72 may be used to separate storage areas on the rack 72 and/or segregate any furnace vent or intake components on the roof of the sled 12.

Table of parts

| | |
|---|---|
| 10 | camp system |
| 12 | sleds |
| 14 | front end |
| 16 | rear end |
| 18 | top |
| 20 | base |
| 22 | sides |
| 24 | tub base |
| 26 | sloped front end |
| 28 | rear wall |
| 30 | open top |
| 32 | base |
| 34 | side runner ridges |
| 36 | side wall |
| 38 | hollow interior |
| 39 | cover for storage |
| 40 | top peripheral edge |
| 42 | camper unit |
| 44 | front wall |
| 46 | rear wall |
| 48 | ceiling |
| 50 | side walls |
| 52 | hollow interior sleeping area |
| 54 | bed |
| 56 | user |
| 58 | window |
| 60 | door hatch opening |
| 62 | door |
| 64 | seating surface provided by door when open |
| 65 | door legs |
| 66 | hinges |
| 67 | hinge between door legs and seating surface |
| 68 | lock |
| 70 | gas struts to raise and lower door |
| 72 | roof rack |
| 73 | divider on roof rack |
| 74 | frame walls |
| 76 | top peripheral edge |
| 78 | tarpaulin |
| 80 | first segment |
| 82 | mating end edge |
| 84 | mating base edge |
| 86 | second segment |
| 88 | mating end edge |
| 90 | mating base edge |
| 92 | end walls |
| 94 | door |
| 96 | window |
| 98 | side walls |
| 100 | roof |
| 102 | vent in the roof |
| 104 | interior |
| 106 | sled zones |
| 108 | living space zone |
| 110 | ground surface |
| 112 | tow connector |
| 113 | tow connector mount |
| 114 | snowmobile |
| 116 | stove compartment |
| 117 | removable furnace section |
| 118 | door of stove compartment |
| 120 | stove burner |
| 122 | brace |
| 124 | hinge of stove door |
| 126 | furnace compartment |
| 128 | door of furnace |
| 130 | furnace |
| 131 | structural frame |
| 132 | handle |
| 134 | air return grating |
| 136 | hose connector/hot air supply conduit |
| 137 | fresh air intake |
| 138 | hinge of front furnace door |
| 140 | ledge brace |
| 142 | diesel supply tank |
| 144 | combustion intake |
| 146 | furnace exhaust |
| 147 | furnace exhaust bracket |
| 148 | air return passage |
| 150 | heat exchanger |
| 152 | fuel line |
| 154 | fuel pump |
| 156 | fuel filter |
| 158 | rear furnace door |
| 160 | rear furnace door hinge |
| 162 | compartment above furnace compartment |
| 164 | partition shelf |
| 166 | collapsible tent poles |
| 168 | pockets or mounts for tent pole ends |

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A camp system comprising:
a plurality of sleds spaced from one another about a ground surface; and
a tarpaulin secured in a deployed position between the plurality of sleds and defining an enclosed interior camping area.

2. The camp system of claim 1 in which one or more sleds of the plurality of sleds comprise a hollow tub base.

3. The camp system of claim 2 in which the hollow tub base comprises plastic.

4. The camp system of claim 2 in which the one or more sleds of the plurality of sleds each form a camper housing, with side walls and a roof mounted over the hollow tub base and defining an enclosed interior sleeping area.

5. The camp system of claim 4 in which the camper housing comprises a bed within the interior sleeping area.

6. The camp system of claim 5 in which the bed is sized for one or more average adults.

7. The camp system of claim 2 in which the one or more sleds of the plurality of sleds are passive sleds.

8. The camp system of claim 7 in which the passive sleds each comprise a tow mount at a front end of the passive sled.

9. The camp system of claim 2 in which the one or more sleds each comprise runners.

10. The camp system of claim 1 in which the one or more sleds each comprise a furnace.

11. The camp system of claim 1 deployed over a snowy or icy ground surface.

12. The camp system of claim 1 in which the tarpaulin is mounted, at least in part, to one or more of the plurality of sleds.

13. The camp system of claim 12 in which the tarpaulin is mounted to move between the deployed position and a stowed position where the tarpaulin is stowed on or within the one or more of the plurality of sleds.

14. The camp system of claim 12 in which the tarpaulin is formed of a plurality of tarpaulin modules, with each of the plurality of sleds mounting a respective tarpaulin module of the plurality of tarpaulin modules, and with each of the plurality of tarpaulin modules being reversibly securable to the other tarpaulin modules to form the tarpaulin when in the deployed position.

15. The camp system of claim 14 in which each of the plurality of tarpaulin modules is reversibly securable to one or more other tarpaulin modules by a zipper, strap, tie down, or hook and loop fastening system.

16. A sled for use in the camp system of claim 1.

17. A method comprising:
arranging a plurality of sleds at a camp site; and
deploying a tarpaulin to or over the plurality of sleds to form an enclosed interior camping area between the plurality of sleds.

18. The method of claim 17 further comprising transporting the plurality of sleds and tarpaulin to the camp site.

19. The method of claim 18 in which transporting comprises pulling the plurality of sleds using all-terrain vehicles.

20. The method of claim 19 in which the all-terrain vehicles comprise snowmobiles.

21. A passive sled module comprising:
a hollow tub base;
a camper housing with side walls and a roof mounted over the hollow tub base and defining an enclosed interior sleeping area with a bed within the interior sleeping area; and
a tow mount at a front end of the passive sled.
